(19) United States
(12) Patent Application Publication
(10) Pub. No.: US 2016/0168514 A1
(43) Pub. Date: Jun. 16, 2016

(54) Method for Washing and Cleaning Textiles

(71) Applicant: WEYLCHEM SWITZERLAND AG, Muttenz (CH)

(72) Inventors: Johannes HIMMRICH, Eppstein (DE); Hans Jürgen SCHOLZ, Alzenau (DE); Wolfgang WALTHER, Kriftel (DE); Joachim ERBES, Frankfurt am Main (DE); Stefan RIEGELBECK, Frankfurt (DE)

(21) Appl. No.: 14/773,592

(22) PCT Filed: Mar. 10, 2014
(86) PCT No.: PCT/EP2014/000611

§ 371 Date: Sep. 8, 2015

(30) Foreign Application Priority Data
Mar. 15, 2013 (DE) 10 2013 004 428.6

(51) Int. Cl. C11D 3/386; C11D 3/39; C11D 1/83; C11D 1/22; C11D 1/14

(52) U.S. Cl. CPC C11D 3/38618; C11D 1/22; C11D 1/146; C11D 1/83; C11D 3/3917

(57) ABSTRACT

A method is described for washing and cleaning textiles, wherein
A) a liquid composition comprising one or more surfactants and one or more enzymes but no bleaching agents is added to the washing liquor comprising water and the textiles to be washed and cleaned and
B) 15 to 30 minutes after adding the liquid composition to the washing liquor, one or more bleaching agents are metered into the washing liquor.

The method is characterized in particular by an advantageous washing and cleaning power.

### CLAIM FOR PRIORITY

This application is a national phase application of PCT/EP2014/000611 FILED Mar. 10, 2014 which was based on application DE 10 2013 004 428.6 FILED Mar. 15, 2013. The priorities of PCT/EP2014/000611 and DE 10 2013 004 428.6 are hereby claimed and their disclosures incorporated herein by reference.

### TECHNICAL FIELD

The invention relates to a method for washing and cleaning textiles wherein, in the washing and cleaning process, firstly a liquid composition, i.e. a liquid detergent, comprising one or more surfactants and one or more enzymes but no bleaching agents is used and, only after a time delay, one or more bleaching agents are used.

### BACKGROUND

Liquid detergents are enjoying greatly increasing popularity in the market because they can be dosed easily and without dust formation, rapidly release the washing-active ingredients upon washing and, moreover, do not leave behind residues on the laundry.

However, a major disadvantage of the liquid detergents from the prior art is often their low compatibility with bleaching agent systems and their poor washing and cleaning power, particularly in the case of enzyme-sensitive and bleachable soilings.

It was therefore the object to provide a method for washing and cleaning textiles using liquid detergents which avoids, or at least reduces, the disadvantages of the prior art and is characterized in particular by an advantageous washing and cleaning power.

### SUMMARY OF INVENTION

Surprisingly, it has been found that this object is achieved by a method for washing and cleaning textiles, wherein
A) a liquid composition comprising one or more surfactants and one or more enzymes but no bleaching agents is added to the washing liquor comprising water and the textiles to be washed and cleaned and
B) 15 to 30 minutes after adding the liquid composition to the washing liquor, one or more bleaching agents are metered into the washing liquor.

The invention therefore provides a method for washing and cleaning textiles, which comprises
A) adding a liquid composition comprising one or more surfactants and one or more enzymes but no bleaching agents to the washing liquor comprising water and the textiles to be washed and cleaned and
B) 15 to 30 minutes after adding the liquid composition to the washing liquor, metering one or more bleaching agents into the washing liquor.

When using the method according to the invention, an advantageous washing and cleaning power in particular toward enzyme-sensitive and bleachable soilings is attained. The washing and cleaning power of the method according to the invention is significantly greater than that in methods in which bleaches on the one hand and surfactants and enzymes, preferably enzymes, on the other hand are used simultaneously.

WO 01/60966 A1 describes a composition in a water-soluble pouch, where the pouch comprises at least two compartments and each compartment contains a different component of the composition, wherein a first compartment contains a first constituent, where the first constituent comprises a liquid matrix and a peracid source. The compositions are used in washing methods.

WO 02/08380 A1 discloses an article comprising a first pouch made of a water-soluble material which comprises the following in its inside: a) a first solid or liquid composition and b) a second pouch made of a water-soluble material which comprises a second solid or liquid composition in its inside. The article can comprise for example textile cleaning compositions or textile care compositions.

EP 2 014 756 A1 describes a pouch for detergent applications made of a water-soluble film which comprises at least two compartments, where the first compartment contains a liquid component comprising a bleach activator and the second compartment contains a solid component comprising a peroxide source.

WO 2011/159510 A1 discloses a multicompartment pouch comprising a first compartment and a second compartment, where the first compartment contains a solid composition and the solid composition comprises an oxygen bleach source, a bleach activator and a polycarboxylate polymer, and the second compartment contains a liquid composition and the liquid composition comprises a solvent with a low molecular weight. The solid and/or liquid compositions can optionally also comprise other ingredients which are usually present in detergent compositions.

### DETAILED DESCRIPTION

Within the context of the present invention, “liquid” compositions are understood as meaning all liquid or flowable presentation forms. Within the context of the present invention, liquid or flowable compositions are those which are pourable and have viscosities of from 5 to 60 000 mPas. The viscosity can be measured using customary standard methods (for example Brookfield viscometer LVT-II at 20 revolutions/minute and 20° C.), with spindle 2 being used for the viscosity range 5 to <1000 mPas, spindle 3 being used for 1000 to <5000 mPas, spindle 4 for 5000 to <10 000 mPas and spindle 7 for 10 000 to 60 000 mPas.

Preferably, the liquid compositions have viscosities of from 100 to 20 000 mPas, particularly preferably from 300 to 10 000 mPas and especially preferably from 400 to 5000 mPas.

The liquid compositions can be gel-like or also paste-like, they may be present as homogeneous solutions or as suspensions, be supplied in so-called pouches or be confectioned in otherwise customary presentation forms.

Preferably, the liquid composition comprises one or more anionic surfactants selected from the surfactant classes of the sulfonates, sulfates, carboxylates and phosphates, the counterions of which are selected from the group consisting of the cations of sodium, potassium, calcium, magnesium, NH₄⁺ and quaternary ammonium ions [HNR¹R²R³]⁺, where R¹, R² and R³, independently of one another, can be hydrogen, a linear or branched alkyl group having 1 to 22 carbon atoms, a linear or branched, mono- or polyunsaturated alkenyl group having 2 to 22 carbon atoms, a linear monohydroxyalkyl group having 2 to 10 carbon atoms, preferably a monohydroxyethyl or monohydroxypropyl group, and also a linear or branched dihydroxyalkyl group having 3 to 10 carbon atoms.

Among these, in turn, with preference the liquid composition comprises one or more anionic surfactants and the one or more anionic surfactants of the liquid composition is or are selected from the surfactant classes of the sulfonates, sulfates, carboxylates and phosphates and the counterions of the anionic surfactants of the liquid composition may be selected from the group consisting of the cations of sodium, potassium, calcium, magnesium, NH₄⁺ and quaternary ammonium ions [HNR¹R²R³]⁺, where R¹, R² and R³, independently of one another, can be hydrogen, a linear or branched alkyl group having 1 to 22 carbon atoms, a linear or branched, mono- or polyunsaturated alkenyl group having 2 to 22 carbon atoms, a linear monohydroxyalkyl group having 2 to 10 carbon atoms, preferably a mono-hydroxyethyl or mono-hydroxypropyl group, and also a linear or branched di-hydroxyalkyl group having 3 to 10 carbon atoms.

Preferably, the counterions of the one or more anionic surfactants are selected from the surfactant classes of the sulfonates, sulfates, carboxylates and phosphates selected from the group consisting of the cations of sodium, potassium, calcium and magnesium.

Particularly preferably, the liquid composition comprises one or more secondary paraffinsulfonates. Secondary paraffinsulfonates are surfactants which contain, in statistical distribution, predominantly one SO₃X group in the secondary position on the paraffin hydrocarbon chain and, to a lesser extent, two or more SO₃X groups in the secondary position on the paraffin hydrocarbon chain (X=counterion). The paraffin hydrocarbon chains are predominantly linear and only to a small fraction of 5% by weight or less branched paraffin chains having 8 to 22 carbon atoms. Particular preference is given to secondary paraffinsulfonates having 13 to 17 carbon atoms in the paraffin group.

Furthermore, preference is given to primary sulfonates, preferably alkane- or alkenesulfonates, where the alkyl or alkenyl group can either be branched or linear and can be optionally substituted with a hydroxyl group. The preferred primary sulfonates contain linear alkyl or alkenyl chains having 9 to 25 carbon atoms, preferably having 10 to 20 carbon atoms and particularly preferably having 13 to 17 carbon atoms.

Preference is likewise given to olefinsulfonates which are obtained by sulfonation of C₁₂-C₂₄—, preferably C₁₄-C₁₆-α-olefins with sulfur trioxide and subsequent neutralization. As a consequence of the preparation process, these olefinsulfonates can contain relatively small amounts of hydroxyalkanesulfonates and alkanedisulfonates.

Preference is likewise given to alkenyl- or alkylbenzenesulfonates. The alkenyl or alkyl group can be branched or linear and optionally substituted with a hydroxyl group. The preferred alkylbenzenesulfonates contain linear alkyl chains having 9 to 25 carbon atoms and preferably having 10 to 13 carbon atoms.

Preference is likewise given to ester sulfonates of the formula (1)

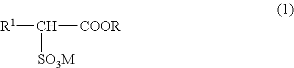

in which
R¹ is a C₈-C₂₀-hydrocarbon radical, preferably alkyl, and
R is a C₁-C₆ hydrocarbon radical, preferably alkyl.
M is a cation, which forms a water-soluble salt with the ester sulfonate.

Particular preference is given to methyl ester sulfonates, in which R¹ is C₁₀-C₁₆-alkyl and R is methyl.

Preferred sulfates are water-soluble salts of the formula ROSO₃M, in which R is a C₁₀-C₂₄-hydrocarbon radical, preferably an alkyl or hydroxyalkyl radical with C₁₀-C₂₀-alkyl component, particularly preferably a C₁₂-C₁₈ alkyl or hydroxyalkyl radical. M is sodium, potassium, calcium, magnesium or a mixture thereof.

Preferred ether sulfates are water-soluble salts of the linear formula RO(A)ₘSO₃M in which R is an unsubstituted C₁₀-C₂₄-hydrocarbon radical, preferably C₁₀-C₂₄-alkyl radical, or is a C₁₀-C₂₄-hydrocarbon radical substituted by a hydroxyl group, preferably a C₁₀-C₂₄-hydroxyalkyl radical, particularly preferably a C₁₂-C₂₀ alkyl or hydroxyalkyl radical, especially preferably a C₁₂-C₁₈-alkyl or hydroxyalkyl radical. A is an ethoxy (EO) or propoxy (PO) unit, m is a number greater than 0, preferably between 0.5 and 6, particularly preferably between 0.5 and 3 and M is a cation such as e.g. sodium, potassium, calcium, magnesium or a mixture thereof.

Particular preference is given to C₁₂- to C₁₈-fatty alcohol ether sulfates, where the content of EO is 1, 2, 2.5, 3 or 4 mol per 1 mol of the fatty alcohol ether sulfate and in which M is sodium or potassium.

Further preferred anionic surfactants are carboxylates, in particular fatty acid soaps. The soaps can be saturated or unsaturated and can contain various substituents, such as hydroxyl groups or α-sulfonate groups. Preference is given to linear saturated or unsaturated hydrocarbon radicals as hydrophobic fraction having 6 to 30 and preferably 10 to 18 carbon atoms.

Furthermore, the liquid composition particularly preferably comprises one or more anionic surfactants which are selected from the group consisting of the salts of lauric acid, myristic acid, palmitic acid, stearic acid, behenic acid, hydrogenated erucic acid, oleic acid, linoleic acid, linolenic acid and mixtures thereof and the salts of the fatty acids or fatty acid mixtures of natural fats and oils, preferably of coconut oil, soybean oil, rapeseed oil, sunflower oil, canola oil, palm fat oil, palm kernel oil, olive oil and tallow fat.

Preferably, the liquid composition comprises one or more nonionic surfactants selected from the surfactant classes of the alkoxylated fatty alcohols, fatty acid amides, alkoxylated fatty acid amides, alkylphenol polyglycol ethers, amine oxides, polyhydroxy fatty acid amides and alkyl polyglycosides.

Among these in turn, the liquid composition preferably comprises one or more nonionic surfactants and the one or more nonionic surfactants of the liquid composition is or are selected from the surfactant classes of the alkoxylated fatty alcohols, fatty acid amides, alkoxylated fatty acid amides, alkylphenol polyglycol ethers, amine oxides, polyhydroxy fatty acid amides and alkyl polyglycosides.

The alkyl or alkenyl chain of the alkoxylated fatty alcohols can be linear or branched, primary or secondary, and contains in general 8 to 22 carbon atoms. Particularly preferably, the liquid composition comprises one or more nonionic surfactants which are selected from condensation products of C₁₀- to C₂₀-alcohols with 2 to 18 mol of ethylene oxide per 1 mol of alcohol. The alcohol ethoxylates can have a narrow homolog distribution of the ethylene oxide (“Narrow Range Ethoxylates”) or a broad homolog distribution of the ethylene oxide (“Broad Range Ethoxylates”). Examples of commercially obtainable nonionic surfactants of this type are Tergitol® 15-S-9 (condensation product of a linear secondary C₁₁-C₁₅-alcohol with 9 mol of ethylene oxide), Tergitol® 24-L-NMW (condensation product of a linear primary C₁₂-C₁₄-alcohol with 6 mol of ethylene oxide for a narrow molecular weight distribution). This product class likewise includes the Genapol® brands from Clariant.

Furthermore, preference is given to fatty acid amides according to formula (2)

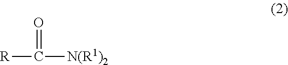

in which
R is an alkyl group having 7 to 21, preferably 9 to 17, carbon atoms and
each radical R′ is hydrogen, C₁-C₄-alkyl, C₁-C₄-hydroxyalkyl or (C₂H₄O)ₓH,
   where x varies from 1 to 3.

Preference is given to C₈-C₂₀-amides, -monoethanolamides, -diethanolamides and -isopropanolamides.

Preference is likewise given to polyethylene, polypropylene and polybutylene oxide condensates of alkylphenols. These compounds include the condensation products of alkylphenols with a C₆- to C₂₀-alkyl group, which can either be linear or branched, with alkene oxides. These surfactants are referred to as alkylphenol alkoxylates, e.g. alkylphenol ethoxylates.

Furthermore, preference is given to water-soluble amine oxides of the formula (3)

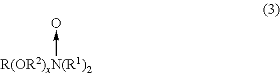

Here, R is an alkyl, hydroxyalkyl or alkylphenol group with a chain length from 8 to 22 carbon atoms,
R² is an alkylene or hydroxyalkylene group with 2 to 3 carbon atoms or mixtures thereof,
each radical R¹ is an alkyl or hydroxyalkyl group having 1 to 3 carbon atoms or a polyethylene oxide group having 1 to 3 ethylene oxide units and
x is a number from 0 to 10.

Preference is likewise given to using polyhydroxy fatty acid amides of the formula (4)

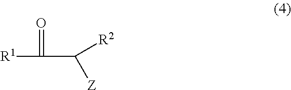

where
R¹ CO is an aliphatic acyl radical having 6 to 22 carbon atoms,
R² is hydrogen, an alkyl or hydroxyalkyl radical having 1 to 4 carbon atoms and
Z is a linear or branched polyhydroxyalkyl radical having 3 to 10 carbon atoms and 3 to 10 hydroxyl groups.

Preference is likewise given to alkyl polyglycosides of the formula RO(G)ₓ, where R is a primary straight-chain or methyl-branched, in particular 2-methyl-branched, aliphatic radical having 8 to 22, preferably 12 to 18 carbon atoms, and G is a glucose unit having 5 or 6 carbon atoms, preferably glucose. The degree of oligomerization x, which indicates the distribution of monoglycosides and oligoglycosides, is preferably a number between 1 and 10, particularly preferably x is between 1.2 and 1.4.

In a preferred embodiment of the invention, the liquid composition comprises one or more alkanolamines or salts thereof.

In a further preferred embodiment of the invention, the liquid composition is free from alkanolamines and salts thereof. This means, for example, that these substances are also not considered as counterions of the anionic surfactants.

Preferably, the liquid composition comprises one or more anionic surfactants and one or more nonionic surfactants.

Particularly preferably, the liquid composition comprises one or more anionic surfactants and one or more nonionic surfactants and the total concentration of the one or more anionic surfactants and of the one or more nonionic surfactants together in the liquid composition is >10.0% by weight, based on the total weight of the liquid composition.

Particularly preferably, the liquid composition comprises one or more anionic surfactants and one or more nonionic surfactants and the total concentration of the one or more anionic surfactants and of the one or more nonionic surfactants together in the liquid composition is >25.0% by weight, based on the total weight of the liquid composition.

In an extraordinarily preferred embodiment of the invention, the liquid composition comprises one or more anionic surfactants and one or more nonanionic surfactants and the total concentration of the one or more anionic surfactants and of the one or more nonionic surfactants together in the liquid composition is from 30 to 50% by weight, based on the total weight of the liquid composition.

In a further extraordinarily preferred embodiment of the invention, the liquid composition comprises one or more anionic surfactants and one or more nonionic surfactants and the total concentration of the one or more anionic surfactants and of the one or more nonionic surfactants together in the liquid composition is >50% by weight and very particularly preferably >50 to 80% by weight, based on the total weight of the liquid composition.

Furthermore particularly preferably, the liquid composition comprises one or more anionic surfactants and one or more nonionic surfactants and the one or more anionic surfactants of the liquid composition and the one or more nonionic surfactants of the liquid composition is or are present in the liquid composition in a weight ratio of anionic surfactant to nonionic surfactant of from 10:1 to 1:10, particularly preferably from 5:1 to 1:5, especially preferably from 3:1 to 1:3 and extraordinarily preferably from 2:1 to 1:2.

In a further preferred variant of the invention, the liquid composition comprises at least 10% by weight, in particular 10 to 50% by weight and very particularly preferably 20 to 40% by weight, based on the total weight of the liquid composition, of anionic surfactants.

In a further preferred variant of the invention, the liquid composition comprises at least 1 to 30% by weight and particularly preferably 5 to 20% by weight, based on the total weight of the liquid composition, of nonionic surfactants.

In a further preferred variant of the invention, the liquid composition comprises anionic surfactants and nonionic surfactants, where the content of anionic surfactants is greater than the content of nonionic surfactants, and where the content of anionic surfactants is very particularly preferably 20 to 40% by weight and the content of nonionic surfactants is very particularly preferably 5 to 20% by weight, and where the weight data are based on the total weight of the liquid composition.

Enzymes which can be used are conventional enzymes. Preferably, the liquid composition comprises one or more enzymes selected from the group consisting of proteases, amylases, mannases, lipases, endolases, pectinases, cellulases, pullinases, cutinases and peroxidases.

Available proteases are, for example, Liquanase® Ultra 2.0 XL, BLAP®, Opticlean®, Maxacal®, Maxapem®, Esperase®, Savinase®, Purafect®, OxP and/or Duraxym®,

available amylases are, for example, Steinzyme® Plus 12L, Termamyl®, Amylase® LT, Maxamyl®, Duramyl® and/or Pruafect® Ox,
available mannases are, for example, Mannaway 4.0 L,
available lipases are, for example, Lipex® 100 L, Lipolase®, Lipomax®, Lumafast® and/or Lipozym®,
available endolases are, for example, Endolase® 5000L,
available pectinases are, for example, Pectinex 3X L and/or Pectinex Ultra SPL and
available cellulases are, for example, Carezyme 1000 L and/or Celluclast 1.5 L.

Preferably, the total concentration of the one or more enzymes and preferably of the one or more enzymes selected from the group consisting of proteases, amylases, mannases, lipases, endolases, pectinases, cellulases, pullinases, cutinases and peroxidases in the liquid composition is at least 0.001% by weight, particularly preferably 0.01 to 10% by weight, especially preferably 0.1 to 5% by weight and extraordinarily preferably 1 to 3% by weight, based on the total weight of the liquid composition.

Preferably, the one or more bleaching agents is or are used in an amount such that the weight ratio of the one or more surfactants of the liquid composition to the one or more bleaching agents is from 100:1 to 1:1, particularly preferably from 50:1 to 2:1, especially preferably from 40:1 to 4:1 and extraordinarily preferably from 30:1 to 5:1.

Bleaching agents are to be understood firstly as meaning compounds which react with bleach activators and in so doing form peroxy acids which bleach much more effectively than the bleaching agents on their own at low temperatures (e.g. <70° C.).

Suitable bleaching agents of this type are hydrogen peroxide and inorganic persalts, preferably percarbonates, perborates, persulfates and persilicates, in particular in the form of alkali metal salts. Particularly preferred bleaching agents of this type are hydrogen peroxide, sodium perborate (monohydrate and tetrahydrate) and/or sodium percarbonate, particularly preferably sodium perborate (monohydrate and tetrahydrate) and/or sodium percarbonate.

In a particularly preferred embodiment of the invention, therefore, the one or more bleaching agent or agents is or are selected from the group consisting of sodium perborate (monohydrate and tetrahydrate) and sodium percarbonate.

Bleaching agents are secondly to be understood as meaning compounds which work without bleach activator. Suitable bleaching agents of this type are peracids or salts thereof.

Particularly preferred peracids or peracid salts are peroxycarboxylic acids and salts thereof according to the formula

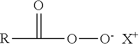

where R is an alkyl group, aralkyl group, cycloalkyl group, aryl group or heterocyclic group, preferably a linear or branched, substituted or unsubstituted alkyl group, especially preferably an alkyl group having 6 to 9 carbon atoms, and X⁺ is a suitable counterion, preferably an H⁺, potassium ion or sodium ion. Preference is given to peroxyhexanoic acid, peroxyheptanoic acid, peroxyoctanoic acid, peroxynonanoic acid, peroxydecanoic acid and salts thereof.

Further particularly preferred peracids or peracid salts are peroxysulfonic acids and salts thereof according to the formula

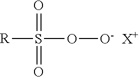

where R is an alkyl group, aralkyl group, cycloalkyl group, aryl group or heterocyclic group, preferably a linear or branched, substituted or unsubstituted alkyl group, especially preferably an alkyl group having 6 to 9 carbon atoms, and X⁺ is a suitable counterion, preferably H⁺, a potassium ion or sodium ion.

Furthermore particularly preferred peracids or peracid salts are peroxophthalic acids and salts thereof, phthaliminoperacids and salts thereof, diperoxycarboxylic acids and salts thereof or peroxysulfuric acids and salts thereof.

Among the bleaching agents which work without bleach activator, preference is given in particular to the peracids or salts thereof which are selected from the group consisting of monoperoxyphthalic acid and its salts, N,N-phthaloylaminoperoxycaproic acid (PAP) and its salts, diperazelaic acid and its salts, diperdodecanedioic acid and its salts and monoperoxysulfuric acid and its salts, the salts preferably being selected from the sodium salts and/or potassium salts. Among monoperoxysulfuric acid and its salts, preference is given in particular to potassium peroxymonosulfate (available under the trade name Caroat).

In a further particularly preferred embodiment of the invention, the bleaching agent is N,N-phthaloylaminoperoxycaproic acid.

In a preferred embodiment of the invention, the one or more bleaching agent or agents is or are metered into the washing liquor in solid form.

In a further preferred embodiment of the invention, the one or more bleaching agent or agents, on the other hand, is or are metered into the washing liquor in liquid form. The term “liquid” here is to be understood as above in connection with the explanation of the “liquid compositions”.

The one or more bleaching agents can be used in the method according to the invention either without bleach activator or with one or more bleach activators.

In a preferred embodiment of the method according to the invention, it takes place in the presence of one or more bleach activators.

If a bleach activator is used, this can be achieved for example by the liquid composition already comprising one or more bleach activators. If, however, the liquid composition does not comprise a bleach activator, the one or more bleach activators can be used in the method according to the invention in addition to the liquid composition. Here, the one or more bleach activators can either be used in the method according to the invention separately from or together with the bleaching agent.

In a preferred embodiment of the method according to the invention, therefore, the one or more bleach activators is or are present in the liquid composition.

In a further preferred embodiment of the method according to the invention, the one or more bleach activators, by contrast, is or are metered into the washing liquor together with the one or more bleaching agents, preferably in the form of a mixture.

The method according to the invention can for example also take place by the liquid composition comprising bleach activator and further bleach activator additionally being added in the method.

Bleach activators that can be used in the method according to the invention are one or more substances selected from the following group: polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyloxy- or n-lauroyloxybenzenesulfonate (NOBS or LOBS), acylated phenolcarboxylic acids, in particular nonanoyloxy- or decanoyloxybenzoic acid (NOBA or DOBA), carboxylic anhydrides, in particular phthalic anhydride, acylated polyhydric alcohols, in particular triacetin, ethylene glycol diacetate and 2,5-diacetoxy-2,5-dihydrofuran, and acylated sorbitol and mannitol, or mixtures thereof (SORMAN), acylated sugar derivatives, in particular pentaacetylglucose (PAG), pentaacetylfructose, tetraacetylxylose and octaacetyllactose, and acetylated, optionally N-alkylated glucamine and gluconolactone, and/or N-acylated lactams, for example N-benzoylcaprolactam. Hydrophilically substituted acylacetals and acyllactams are likewise preferably used. In addition, nitrile derivatives such as n-methylmorpholinium acetonitrile methylsulfate (MMA) or cyanomorpholine (MOR) can be used as bleach activators. Combinations of conventional bleach activators can also be used.

Particularly preferably, the one or more bleach activators is or are selected from the group consisting of tetraacetylethylenediamine, decanoyloxybenzoic acid, n-nonanoyloxybenzenesulfonate and n-lauroyloxybenzenesulfonate.

In a preferred embodiment of the method according to the invention, the one or more bleach activators is or are used in an amount such that the weight ratio of the one or more bleaching agents to the one or more bleach activators is from 25:1 to 1:1 and particularly preferably from 10:1 to 1.5:1.

In a preferred embodiment of the invention, the liquid composition comprises one or more bleach activators, preferably in an amount of 1-10% by weight, particularly preferably in an amount of 1.5-7% by weight and particularly preferably in an amount of 2-6% by weight, in each case based on the total weight of the liquid composition.

If bleach activators are used in the method according to the invention but are not present in the liquid composition, they are likewise used in an amount as if they were present in the liquid composition. Corresponding amounts have been given in the preceding paragraph.

The liquid composition can be used for example in the form of a multicompartment system, a multicompartment bottle or a multicompartment pouch separate from the bleaching agent and optionally separate from the bleach activator, if a bleach activator is used at all, in the method according to the invention. In the method according to the invention, the liquid composition, the one or more bleaching agents and optionally the one or more bleach activators, if a bleach activator is used at all, but e.g. also separately from one another (or the one or more bleach activators, if used, for example also in the liquid composition or for example also together with the one or more bleaching agents such as e.g. in the form of a mixture) can be combined directly during the washing and cleaning of the textiles.

Besides the aforementioned anionic and nonionic surfactants, further constituents which may be present in the liquid compositions are also amophoteric and cationic surfactants, bleach activators, builders, cobuilders, washing alkalis, bleach catalysts, sequestrants, soil release polymers, graying inhibitors, color transfer inhibitors, color fixatives, complexing agents, optical brighteners, softening components, dyes, fragrances, emulsifiers, hydrotropes, organic solvents, and water.

Suitable amphoteric and zwitterionic surfactants are alkylbetaines, alkylamidobetaines, aminopropionates, aminoglycinates or amphoteric imidazolinium compounds according to the formula (5)

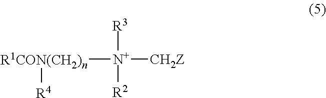

in which
R¹ is C₈-C₂₂-alkyl or -alkenyl,
R² is hydrogen or CH₂CO₂M,
R³ is CH₂CH₂OH or CH₂CH₂OCH₂CH₂CO₂M,
R⁴ is hydrogen, CH₂CH₂OH or CH₂CH₂COOM,
Z is CO₂M or CH₂CO₂M,
n is 2 or 3, preferably 2,
M is hydrogen or a cation such as alkali metal, alkaline earth metal.

Preferred amphoteric surfactants of this formula are monocarboxylates and dicarboxylates. Examples thereof are cocoamphocarboxypropionate, cocoamidocarboxypropionic acid, cocoamphocarboxyglycinate (or also referred to as cocoamphodiacetate) and cocoamphoacetate.

Further preferred amphoteric surfactants are alkyldimethylbetaines and alkyldipolyethoxybetaines with an alkyl radical having 8 to 22 carbon atoms, which can be linear or branched, preferably having 8 to 18 carbon atoms and particularly preferably having 12 to 18 carbon atoms. These compounds are marketed e.g. by Clariant under the trade name Genagen® LAB.

If the liquid compositions comprise one or more amphoteric surfactants, these are preferably present therein in an amount of from 0.1-10% by weight and particularly preferably in an amount of from 0.5-5% by weight, in each case based on the total weight of the liquid compositions.

Suitable cationic surfactants are substituted or unsubstituted straight-chain or branched quaternary ammonium salts of the type R¹N(CH₃)₃⁺X⁻, R¹R²N(CH₃)₂⁺X⁻, R¹R²R³N(CH₃)⁺X⁻ or R¹R²R³R⁴N⁺X⁻. The radicals R¹, R², R³ and R⁴ can preferably, independently of one another, be unsubstituted alkyl with a chain length of 8 to 24 carbon atoms, in particular of 10 to 18 carbon atoms, hydroxyalkyl having 1 to 4 carbon atoms, phenyl, C₂- to C₁₈-alkenyl, C₇- to C₂₄-aralkyl, (C₂H₄O)ₓH, where x is from 1 to 3, alkyl radicals containing one or more ester groups, or cyclic quaternary ammonium salts. X is a suitable anion.

Further suitable cationic surfactants are quaternary alkylhydroxyalkylammonium salts according to the formula (6)

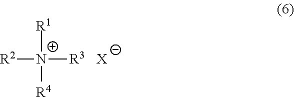

where
R¹ is a linear or branched, saturated or unsaturated alkyl group having 5 to 22 carbon atoms, preferably 8 to 18 carbon atoms, particularly preferably 8 to 14 carbon atoms,
R² is a methyl group,
R³ is a methyl group or like
R⁴ is a group of the formula -A-(PA)ₙ-OH, where A can be a —C₂H₄— and/or —C₃H₆-group and n can be a number from 0 to 20.
X can be any desired anion, for example chloride, bromide, iodide, fluoride, sulfate, hydrogensulfate, carbonate, hydrogencarbonate, acetate, citrate, phosphate, mono- and dihydrogenphosphate, pyrophosphate, polyphosphate, metaphosphate, nitrate, methylsulfate, phosphonate, methylphosphonate, methanedisulfonate, methylsulfonate, ethanesulfonate or an anion of the formulae R⁶SO₃^{θ}, R⁷SO₄^{θ} or R⁶COO^{θ}, in which R⁶ and R⁷ are C₂-C₂₀—, preferably C₁₀-C₁₈-alkyl, and R⁷ is additionally also C₁-C₁₈-alkylphenyl.

Quaternary C₈-C₁₀-alkyldimethylhydroxyethylammonium chloride or -methosulfate and quaternary C₁₂-C₁₄-alkyldimethylhydroxyethylammonium chloride or -methosulfate is extraordinarily preferred.

If the liquid compositions comprise one or more cationic surfactants, these are preferably present therein in an amount of from 0.1-15% by weight and particularly preferably in an amount of 0.5-7% by weight, in each case based on the total weight of the liquid compositions.

If the liquid compositions comprise one or more cationic surfactants, the weight ratio of the one or more cationic surfactants to the one or more anionic surfactants is preferably from 1:10 to 1:5.

Further ingredients which may be present in the liquid compositions include inorganic and/or organic builders and cobuilders, so-called builders, in order to reduce the degree of water hardness.

These builders can be present in the liquid compositions with weight fractions of from 5 to 80%. Inorganic builders include, for example, alkali metal, ammonium and alkanolammonium salts of polyphosphates such as, for example, tripolyphosphates, pyrophosphates and glass-like polymeric metaphosphates, phosphonates, silicates, carbonates including bicarbonates and sesquicarbonates, sulfates and aluminosilicates.

Examples of silicate builders are the alkali metal silicates, in particular those with an SiO₂:Na₂O ratio between 1.6:1 and 3.2:1, and also sheet silicates, for example sodium sheet silicates, as described in U.S. Pat. No. 4,664,839, available from Clariant under the brand SKS®. SKS-6® is a particularly preferred sheet silicate builder.

Aluminosilicate builders are particularly preferred. These are in particular zeolites with the formula Na_{z}[(AlO₂)_{z}(SiO₂)_{y}].xH₂O, in which z and y are integers of at least 6, the ratio of z to y is from 1.0 to 0.5, and x is an integer from 15 to 264.

Suitable ion exchangers based on aluminosilicate are commercially available. These aluminosilicates may be of crystalline or amorphous structure, and can be naturally occurring or else prepared synthetically.

Preferred ion exchangers based on synthetic crystalline aluminosilicates are available under the name Zeolith A, Zeolith P(B) (including those disclosed in EP-A-0 384 070) and Zeolith X.

Suitable organic builders include polycarboxyl compounds, such as, for example, etherpolycarboxylates and oxydisuccinates, as described for example in U.S. Pat. No. 3,128,287 and U.S. Pat. No. 3,635,830. Likewise, reference should be made to “TMS/TDS” builders from U.S. Pat. No. 4,663,071.

Other suitable builders include the ether hydroxypolycarboxylates, copolymers of acrylic acid with maleic anhydride, of maleic anhydride with ethylene or vinyl methyl ether, 1,3,5-trihydroxybenzene-2,4,6-trisulfonic acid and carboxymethyloxysuccinic acid, the alkali metal, ammonium and substituted ammonium salts of polyacetic acids such as e.g. ethylenediaminetetraacetic acid and nitrilotriacetic acid, and also polycarboxylic acids, such as mellitic acid, succinic acid, oxydisuccinic acid, polymaleic acid, benzene-1,3,5-tricarboxylic acid, carboxymethyloxysuccinic acid, and soluble salts thereof.

Builders based on citrate, e.g. citric acid and its soluble salts, in particular the sodium salt, are preferred polycarboxylic acid builders, which can also be used together with zeolites and/or sheet silicates.

Further suitable builders are the 3,3-dicarboxy-4-oxa-1,6-hexanedioates and the related compounds which are disclosed in U.S. Pat. No. 4,566,984.

If builders based on phosphorus can be used, various alkali metal phosphates such as, for example, sodium tripolyphosphate, sodium pyrophosphate and sodium orthophosphate, can be used. It is likewise possible to use phosphonate builders, such as ethane-1-hydroxy-1,1-diphosphonate and other known phosphonates, as are disclosed for example in U.S. Pat. No. 3,159,581, U.S. Pat. No. 3,213,030, U.S. Pat. No. 3,422,021, U.S. Pat. No. 3,400,148 and U.S. Pat. No. 3,422,137.

The liquid compositions can comprise washing alkalis which increase the pH of the composition. Carbonates, hydrogencarbonates and silicates, in particular alkali metal carbonates, alkali metal hydrogencarbonates and alkali metal silicates with a molar ratio of SiO₂/M₂O (M=alkali metal atom) of 1:1 to 2.5:1 are suitable.

Suitable bleach catalysts are preferably bleach-boosting transition metal salts or complexes of manganese, iron, cobalt, ruthenium, molybdenum, titanium or vanadium. When using metal salts, preference is given in particular to manganese salts in oxidation states +2 or +3, for example manganese halides, the chlorides being preferred, manganese sulfates, manganese salts of organic acids such as manganese acetates, manganese acetyl acetonates, manganese oxalates, and manganese nitrates.

Furthermore, preference is given to complexes of iron in oxidation states II or III and of manganese in oxidation state II, III, IV or IV, which preferably contain one or more macrocyclic ligand(s) with the donor functions N1 NR, PR, O and/or S. Preference is given to using ligands which have nitrogen donor functions. Preference is given to transition metal complexes which contain, as macromolecular ligands, 1,4,7-trimethyl-1,4,7-triazacyclononane (Me-TACN), 1,4,7-triazacyclononane (TACN), 1,5,9-trimethyl-1-[delta].[theta]-triazacyclododecane (Me-TACD), 2-methyl-1,4,7-trimethyl-1,4,7-triazacyclononane (MeMeTACN) and/or 2-methyl-1,4,7-triazacyclononane (Me/TACN) or bridged ligands such as 1,2-bis-(4,7-dimethyl-1,4,7-triazacyclonono-1-yl) ethane (Me4-DTNE) or derivatives of cyclam or cyclen, such as 1,8-dimethylcyclam, 1,7-dimethylcyclen, 1,8-diethylcyclam, 1,7-diethylcyclen, 1,8-dibenzylcyclam and 1,7-dibenzylcyclen, as are described e.g. in EP 0 458 397, EP 0458 398, EP 0 549 272, WO 96/06154, WO 96/06157 or WO 2006/125517, but in addition also manganese complexes as are known from EP 1 445 305, EP 1 520 910, EP 1 557 457 and WO 2011/095308.

If the liquid compositions comprise one or more bleach catalysts, these are present therein preferably in an amount of from 0.001 to 2% by weight, based on the total weight of the liquid compositions.

Available sequestrants are sodium tripolyphosphate (STPP), ethylenediaminetetracetic acid (EDTA) and salts, nitrilotriacetic acid (NTA), polyacrylate, phosphonate, oxalic acid and salt, citric acid, zeolite, condensed phosphates, carbonates, polycarbonates.

Suitable Soil Release Polymers (SRPs) are polyesters obtainable by polymerization of the components selected from one or more sulfo-group-free aromatic dicarboxylic acids and/or salts thereof, one or more sulfo-group-containing dicarboxylic acids, one or more compounds of the formula R¹O(CHR²CHR³O)ₙH, where R¹ is H, a linear or branched alkyl or alkenyl group having 1 to 22 carbon atoms, preferably C₁-C₄-alkyl and particularly preferably methyl, R² and R³, independently of one another, are hydrogen or an alkyl group having 1 to 4 carbon atoms, preferably hydrogen and/or methyl, and n is a number from 1 to 100, one or more compounds of the formula H—(OCH₂CH₂)ₘ—SO₃X, where m is a number from 1 to 100 and X is hydrogen or an alkali metal ion, and one or more crosslinking polyfunctional compounds.

In a preferred embodiment of the invention, the liquid compositions comprise one or more Soil Release Polymers. If the liquid compositions comprise one or more Soil Release Polymers, these are present therein preferably in an amount of from 0.1 to 10% by weight and particularly preferably in an amount of from 0.2 to 3% by weight, in each case based on the total weight of the liquid compositions.

Suitable graying inhibitors are carboxymethylcellulose, methylcellulose, hydroxyalkylcellulose, methylhydroxyethylcellulose, methylhydroxypropylcellulose, methylcarboxymethylcellulose and polyvinylpyrrolidone.

Color transfer inhibitors are also contemplated, for example polyamine N-oxides such as, for example, poly(4-vinylpyridine N-oxide), e.g. Chromabond S-400, ISP; polyvinylpyrrolidone, e.g. Sokalan® HP 50, BASF and copolymers of N-vinylpyrrolidone with N-vinylimidazole and optionally other monomers.

The liquid compositions can also comprise color fixatives as active substances, for example color fixatives which are obtained by reacting diethylenetriamine, dicyandiamide and amidosulfuric acid, amines with epichlorohydrin, for example dimethylaminopropylamine and epichlorohydrin or dimethylamine and epichlorohydrin or dicyandiamide, formaldehyde and ammonium chloride, or dicyandiamide, ethylenediamine and formaldehyde or cyanamide with amines and formaldehyde or polyamines with cyanamides and amidosulfuric acid or cyanamides with aldehydes and ammonium salts, but also polyamine N-oxides such as, for example, poly-(4-vinylpyridine N-oxide), e.g. Chromabond S-400, ISP; polyvinylpyrrolidone, e.g. Sokalan® HP 50, BASF and copolymers of N-vinylpyrrolidone with N-vinylimidazole and optionally other monomers.

The liquid compositions can comprise complexing agents, for example aminocarboxylates, such as ethylenediamine tetraacetate, N-hydroxyethylethylenediamine triacetate, nitrilotriacetate, ethylenediamine tetrapropionate, triethylenetetraamine hexaacetate, diethylenetriamine pentaacetate, cyclohexanediamine tetraacetate, phosphonates, for example azacycloheptanediphosphonate, Na salt, pyrophosphates, etidronic acid (1-hydroxyethylidene-1,1-diphosphonic acid, 1-hydroxyethane-1,1-diphosphonic acid, acetophosphonic acid) and its salts, aminophosphonates, such as ethylenediamine tetrakis (methylenephosphonat), diethylenetriamine pentakis(methylenephosphonate), aminetrimethylenephosphonic acid, cyclodextrins, and polyfunctionally substituted aromatic complexing agents, such as dihydroxydisulfobenzene or ethylenediamine disuccinates.

Optical brighteners which can be used are cyclic hydrocarbons such as distyrylbenzenes, distyrylbiphenyls, diphenylstilbenes, triazinylaminostilbenes, stilbenyl-2H-triazoles, for example stilbenzyl-2H-naphthol-[1,2-d]triazoles and bis(1,2,3-triazol-2-yl)stilbenes, benzoxazoles, for example stilbenylbenzoxazole and bis(benzoxazole), furans, benzofurans and benzimidazoles, for example bis(benzo[b]furan-2-yl)biphenyl and cationic benzimidazoles, 1,3-diphenyl-2-pyrazoline, coumarin, naphthalimides, 1,3,5-2-yl derivatives, methinecyanin and dibenzothiophene 5,5-oxide.

Preference is given to anionic optical brighteners, in particular sulfonated compounds.

Also suitable are triazinylaminostilbenes, distyrylbiphenyls and mixtures thereof, 2-(4-styrylphenyl)-2H-naphtho[1,2-d]triazole, 4,4′-bis-(1,2,3-triazol-2-yl)stilbene, aminocoumarin, 4-methyl-7-ethylaminocoumarin, 1,2-bis(benzimidazol-2-yl)ethylene, 1,3-diphenylpyrazoline, 2,5-bis(benzooxazol-2-yl)thiophene, 2-styryl-naphtho[1,2-d]oxazole, 2-(4-styryl-3-sulfophenyl)-2H-naphtho[1,2-d]triazole and 2-(stilben-4-yl)-2H-naphthol[1,2-d]triazole.

If the liquid compositions comprise one or more optical brighteners, these are present therein preferably in amounts of from 0.001 to 2% by weight, particularly preferably in amounts of from 0.002 to 0.8% by weight and especially preferably in amounts of from 0.003 to 0.4% by weight, in each case based on the total weight of the liquid compositions.

Softening components which can be used are quaternary ammonium salts of the type

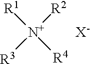

in which
R¹ is C₈-C₂₄ n- or isoalkyl, preferably C₁₀-C₁₈ n-alkyl,
R² is C₁-C₄-alkyl, preferably methyl,
R³ is R¹ or R²,
R⁴ is R² or hydroxyethyl or hydroxypropyl or oligomers thereof and
X⁻ is bromide, chloride, iodide, methosulfate, acetate, propionate or lactate.

Examples thereof are distearyldimethylammonium chloride, ditallowalkyldimethylammonium chloride, ditallowalkylmethylhydroxypropylammonium chloride, cetyltrimethylammonium chloride or else the corresponding benyzl derivatives such as, for example, dodecyldimethylbenzylammonium chloride. Cyclic quaternary ammonium salts, such as, for example, alkylmorpholine derivatives can likewise be used.

Moreover, besides the quaternary ammonium compounds, imidazolinium compounds (1) and imidazoline derivatives (2) can be used.

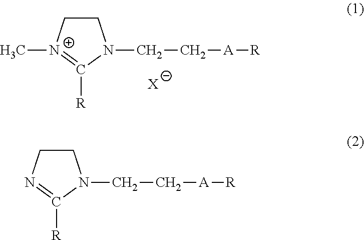

in which
R is C₈-C₂₄ n- or isoalkyl, preferably C₁₀-C₁₈ n-alkyl,
X is bromide, chloride, iodide or methosulfate and
A is —NH—CO—, —CO—NH—, —O—CO— or —CO—O—.

A particularly preferred compound class is the so-called ester quats. These are reaction products of alkanolamines and fatty acids which are then quaternized with customary alkylating agents or hydroxyalkylating agents.

Examples of ester quats are compounds of the formulae:

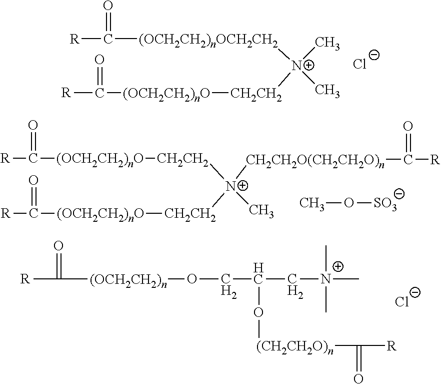

where R—C—O is derived from C₈-C₂₄-fatty acids, which may be saturated or unsaturated. The index n is in the range from 0 to 10, preferably in the range from 0 to 3 and particularly preferably in the range from 0 to 1.

Further preferred fabric softener raw materials are amidoamines based on, for example, dialkyltriamines and long-chain fatty acids, and also their oxethylates and quaternized variants. These compounds have the following structure:

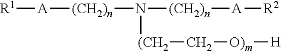

in which
R¹ and R² independently of one another, are C₈-C₂₄ n- or isoalkyl, preferably C₁₀-C₁₈ n-alkyl,
A is —CO—NH— or —NH—CO—,
n is 1 to 3, preferably 2, and
m is 1 to 5, preferably 2 to 4.

By quaternizing the tertiary amino group, it is possible to additionally introduce a radical R³, which may be C₁-C₄-alkyl, preferably methyl, and a counterion X, which may be chloride, bromide, iodide or methylsulfate. Amidoaminoethoxylates and quaternized subsequent products thereof are supplied under the trade names Varisoft® 510, Varisoft® 512, Rewopal® V 3340 and Rewoquat® W 222 LM.

The liquid compositions preferably comprise dyes and fragrances or perfumes.

As dyes, preference is given to Acid Red 18 (CI 16255), Acid Red 26, Acid Red 27, Acid Red 33, Acid Red 51, Acid Red 87, Acid Red 88, Acid Red 92, Acid Red 95, Acid Red 249 (CI) 18134, Acid Red 52 (CI45100), Acid Violet 126, Acid Violet 48, Acid Violet 54, Acid Yellow 1, Acid Yellow 3 (CI 47005), Acid Yellow 11, Acid Yellow 23 (CI 19140), Acid Yellow 3, Direct Blue 199 (CI 74190), Direct Yellow 28 (CI 19555), Food Blue 2 (CI 42090), Food Blue 5:2 (CI 42051:2), Food Red 7 (CI 16255), Food Yellow 13 (CI 47005), Food Yellow 3 (CI 15985), Food Yellow 4 (CI 19140), Reactive Green 12, Solvent Green 7 (CI 59040).

Particularly preferred dyes are water-soluble acid dyes, for example Food Yellow 13 (Acid Yellow 3, CI 47005), Food Yellow 4 (Acid Yellow 23, CI 19140), Food Red 7 (Acid Red 18, CI 16255), Food Blue 2 (Acid Blue 9, CI 42090), Food Blue 5 (Acid Blue 3, CI 42051), Acid Red 249 (CI 18134), Acid Red 52 (CI 45100), Acid Violet 126, Acid Violet 48, Acid Blue 80 (CI 61585), Acid Blue 182, Acid Blue 182, Acid Green 25 (CI 61570), Acid Green 81.

Water-soluble direct dyes, for example Direct Yellow 28 (CI 19555), Direct Blue 199 (CI 74190) and water-soluble reactive dyes, for example Reactive Green 12, and the dyes Food Yellow 3 (CI 15985), Acid Yellow 184 can also likewise preferably be used.

Aqueous dispersions of the following pigment dyes can likewise preferably be used, the concentration of the dye dispersions used for coloring solutions or dispersions preferably being in the range from 0.1 to 50% by weight, particularly preferably in the range from 1 to 45% by weight, especially preferably in the range from 5 to 40% by weight and extraordinarily preferably in the range from 10 to 35% by weight.

It is known to the person skilled in the art that besides the pigments, the aqueous pigment dispersions comprise dispersants and optionally further auxiliaries, for example biocides.

Suitable pigment dyes are Pigment Black 7 (CI 77266), Pigment Blue 15 (CI 74160), Pigment Blue 15:1 (CI 74160), Pigment Blue 15:3 (CI 74160), Pigment Green 7 (CI 74260), Pigment Orange 5, Pigment Red 112 (CI 12370), Pigment Red 112 (CI 12370), Pigment Red 122 (CI 73915), Pigment Red 179 (CI 71130), Pigment Red 184 (CI 12487), Pigment Red 188 (CI 12467), Pigment Red 4 (CI 12085), Pigment Red 5 (CI 12490), Pigment Red 9, Pigment Violet 23 (CI 51319), Pigment Yellow 1 (CI 11680), Pigment Yellow 13 (CI 21100), Pigment Yellow 154, Pigment Yellow 3 (CI 11710), Pigment Yellow 74, Pigment Yellow 83 (CI 21108), Pigment Yellow 97.

In a preferred embodiment of the invention, the following pigment dyes are used in the form of dispersions: Pigment Yellow 1 (CI 11680), Pigment Yellow 3 (CI 11710), Pigment Red 112 (CI 12370), Pigment Red 5 (CI 12490), Pigment Red 181 (CI 73360), Pigment Violet 23 (CI 51319), Pigment Blue 15:1 (CI 74160), Pigment Green 7 (CI 74260), Pigment Black 7 (CI 77266).

In a further preferred embodiment of the invention, water-soluble polymer dyes, for example Liquitint®, Liquitint Blue HP®, Liquitint Blue 65®, Liquitint Patent Blue®, Liquitint Royal Blue®, Liquitint Experimental Yellow 8949-43®, Liquitint Green HMC®, Liquitint Yellow II® and mixtures thereof are used.

Fragrances or perfumes which can be used are individual odorant compounds, e.g. the synthetic products of the ester, ether, aldehyde, ketone, alcohol and hydrocarbon types. Fragrance compounds of the ester type are e.g. benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethylmethylphenyl glycinate, allylcyclohexyl propionate, styrallyl propionate and benzyl salicylate. The ethers include, for example, benzyl ethyl ether; the aldehydes include e.g. the linear alkanals having 8 to 18 carbon atoms, citral, citronellal, citronellyloxyacetaldehyde, hydroxycitronellal, lilial and bourgeonal; the ketones include e.g. the ionones, alpha-isomethylionone and methyl cedryl ketone; the alcohols include anethole, citronellol, eugenol, geraniol, linalool, phenylethyl alcohol and terpineol; the hydrocarbons include primarily the terpenes and balsams. Preference is given to using mixtures of different odorants which together produce a pleasant scent note.

Perfume oils can also comprise natural odorant mixtures, as are accessible from vegetable or animal sources, e.g. pine oil, citrus oil, jasmine oil, lily oil, rose oil or ylang-ylang oil. Essential oils of relatively low volatility, which are mostly used as aroma components, are also suitable as perfume oils, e.g. sage oil, chamomile oil, clove oil, melissa oil, mint oil, cinnamon leaf oil, linden blossom oil and juniper berry oil.

Preference is given to using solutions or emulsions of the aforementioned fragrances and perfume oils, which can be prepared by customary methods.

Suitable emulsifiers are addition products of from 0 to 30 mol of alkylene oxide, in particular ethylene oxide, propylene oxide and/or butylene oxide, onto linear or branched, saturated or unsaturated fatty alcohols having 8 to 22 carbon atoms, onto fatty acids having 12 to 22 carbon atoms, onto alkylphenols having 8 to 15 carbon atoms in the alkyl group and onto sorbitan esters;

(C₁₂-C₁₈)-fatty acid mono- and diesters of addition products of from 0 to 30 mol of ethylene oxide onto gycerol;
glycerol mono- and diesters and sorbitan mono- and diesters of saturated and unsaturated fatty acids having 6 to 22 carbon atoms and optionally ethylene oxide addition products thereof;
addition products of from 5 to 60 mol, preferably 15 to 60 mol, of ethylene oxide onto castor oil and/or hydrogenated castor oil;
polyol and in particular polyglycerol esters, such as e.g. polyglycerol polyricinoleate and polyglycerol poly-12-hydroxystearate.

Furthermore, anionic emulsifiers, such as ethoxylated and non-ethoxylated mono-, di- or triphosphoric acid esters, but also cationic emulsifiers such as mono-, di- and trialkyl quats and polymeric derivatives thereof can be used.

Mixtures of compounds from two or more of these substance classes are likewise suitable.

Suitable hydrotropes are xylenesulfonates, toluenesulfonates and cumenesulfonates in the form of their potassium or sodium salts or mixtures thereof.

In a preferred embodiment of the invention, the liquid compositions comprise one or more hydrotropes in an amount of 1-10% by weight, preferably in an amount of 1-6% by weight and particularly preferably in an amount of 2-5% by weight, in each case based on the total weight of the liquid compositions.

Preferred organic solvents originate from the group of mono- or polyhydric alcohols or glycol ethers. Preferably, the solvents are selected from ethanol, n- or isopropanol, butanol, glycol, propane- or butanediol, glycerol, diglycol, propyl or butyl diglycol, hexylene glycol, ethylene glycol methyl ether, ethylene glycol ethyl ether, ethylene glycol propyl ether, etheylene glycol mono-n-butyl ether, diethylene glycol methyl ether, diethylene glycol ethyl ether, propylene glycol methyl, ethyl or propyl ether, dipropylene glycol methyl, or ethyl ether, methoxy-, ethoxy- or butoxytriglycol, 1-butoxyethoxy-2-propanol, 3-methyl-3-methoxybutanol, propylene glycol t-butyl ether, polyglycols, preferably polyethylene glycols, and mixtures of these solvents.

Furthermore, the liquid compositions comprise water.

In a preferred embodiment of the invention, the amount of water in the liquid compositions is 10 to 60% by weight, preferably 10 to 40% by weight and particularly preferably 10 to 20% by weight, in each case based on the total weight of the liquid compositions.

In a further preferred embodiment of the invention, the amount of water in the liquid compositions is <10% by weight, preferably <8% by weight, particularly preferably <6% by weight and especially preferably <5% by weight, in each case based on the total weight of the liquid compositions.

The minimum amount of water here is preferably 3% by weight, based on the total weight of the liquid compositions.

Preferred liquid compositions have a pH of 7 to 11, preferably of 7.5 to 10 and particularly preferably of 7.5 to 9.

However, it is known to the person skilled in the art that the pH of a liquid composition with a water fraction <40% by weight, based on the total weight of the liquid composition, cannot be ascertained for the liquid composition per se. For liquid compositions with a water fraction <40% by weight, a 1% strength by weight aqueous solution of the liquid composition is prepared and the pH of this is determined by customary methods.

Consequently, the pH values given above are valid for liquid compositions with a water fraction of 40% by weight or greater (based on the total weight of the liquid compositions) directly and for liquid compositions with a water fraction <40% by weight (based on the total weight of the liquid compositions), for a 1% strength by weight aqueous solution of the liquid composition.

The method according to the invention is preferably used for washing and cleaning textiles toward enzyme-sensitive and bleachable soilings.

The washing liquor has a pH of preferably 8.0 to 11.0, particularly preferably of 8.0 to 10.5 and especially preferably of 8.5 to 10.0. The increase in the pH in the washing liquor can be achieved by means of washing alkalis, for example sodium carbonate.

The washing temperature is preferably from 20 to 80° C., particularly preferably from 30 to 60° C. and especially preferably from 40 to 60° C.

Preferably, the method according to the invention is carried out in automatic dishwashers.

The examples below are intended to illustrate the invention without limiting it thereto. Unless explicitly stated otherwise, all percentages are to be understood as meaning percentages by weight (% by weight).

The term “liquid detergent” used in the following example section corresponds to the term “liquid composition” used for the method according to the invention.

Washing experiments were carried out using the following liquid detergent.
Liquid detergent ARIEL Excel Gel

### Composition

| | % by weight |
|---|---|
| linear C₁₀₋₁₃-alkylbenzenesulfonate | 19.8 |
| iso-C₁₀₋₁₄-alkyl ether sulfate, 2.8 EO | 16.9 |
| Soap | 9.7 |
| Iso-C₁₀₋₁₄-oxy alcohol, 7 EO | 8.6 |
| NaCl | 0.1 |
| Na₂SO₄ | 0.1 |
| Borax | 0.4 |
| Citrate | 4.7 |
| Sodium formate | 0.1 |
| 1-hydroxyethane(1,1-diphosphonic acid) | 0.5 |
| (HEDP) | |
| Protease | 0.08 |
| Amylase | 0.10 |
| Copolymer of phosphonic acid and | 0.3 |
| carboxylic acid | |
| Monopropylene glycol | 1.5 |
| Glycerol | 0.2 |
| Monoethanolamine | 5.6 |
| Water | ad 100 |

Bleach activator: 2 g of TAED
   Bleaching agent: 4 g of sodium percarbonate

The washing experiments were carried out under the following conditions:
Washing machine: Miele Novotronic W 927 WPS
Program Boil/colored wash
Loading: 3 kg, two bed sheets 1.50 m×1.50 m (ISO 2267),
   4 pillows 0.80 m x 0.80 m (ISO 2267),
   3 hand towels, cotton bleached
Temperature: 40° C.
Wash cycle: 3 times
Amount of water: 12 liters
Water hardness: 250 ppm CaCO₃ (14° German hardness)
Test cloths: One material sample for each soiling, 15 cm×20 cm

Per wash cycle, 40 g of the liquid detergent ARIEL Excel Gel and in each case a mixture of 2 g of TAED and 4 g of sodium percarbonate were used. In order to adjust the pH of the washing liquor to defined values, sodium carbonate (Na₂CO₃) was added in the following amounts together with the mixture of TAED and sodium percarbonate:

| | Na₂CO₃ |
|---|---|
| pH | (amount in g) |
| 8.5 | 0 |
| 9.0 | 6 |
| 9.5 | 13 |

The addition of the mixture of TAED and sodium percarbonate, and optionally Na₂CO₃ was carried out at time point 0 (at the same time as the dosing of the liquid detergent into the washing liquor) and at time delays of 15 minutes, 30 minutes or 45 minutes after the dosing of the liquid detergent into the washing liquor.

The differences in the reflectance values AR 457 nm between washed and unwashed cotton textiles or cotton (CO)/polyester (PE) mixed fabric were measured. The measured soiled textiles can be acquired commercially.

The following 16 textiles/soilings were measured:

### Test Soilings

| Type | Textile | Soiling | Sensitivity |
|---|---|---|---|
| WFK 10C | CO | Pigment/lanolin | General |
| WFK 20C | CO/PE | Pigment/lanolin | General |
| WFK 10D | CO | Pigment/tallow | General |
| | | grease | |
| WFK 20D | CO/PE | Pigment/tallow | General |
| | | grease | |
| WFK 10RM | CO | Soot/mineral oil | General |
| CFT C216 | CO | Lipstick | General |
| WFK BC-1 | CO | Tea (high washing | Bleach |
| | | temperature) | |
| WFK BC-3 | CO | Tea (low washing | Bleach |
| | | temperature) | |
| CFT CS-3 | CO | Red wine | Bleach |
| WFK 10K | CO | Coffee | Bleach |
| CFT CS-15 | CO | Blueberry | Bleach |
| CFT CS-8 | CO | Grass | Bleach |
| EMPA 112 | CO | Cocoa | Enzymes |
| EMPA 116 | CO | Blood/milk/ink | Enzymes |
| EMPA 162 | CO/PE | Starch | Enzymes |
| CFT CS-27 | CO | Potato starch | Enzymes |

### Measurement:

Instrument: Elrepho 3000 (Datacolor)
Aperture: XLAVØ34 mm
Edge Filter: 400 nm

Table I below shows the sum of the measured differences in the reflectance values AR 457 nm for all 16 soilings for the simultaneous and for the time-delayed addition of the mixture of TAED and sodium percarbonate and for differing alkanity of the washing liquor (pH 8.5, 9.0 and 9.5).

TABLE I
Sum of the measured differences in the
reflectance values ΔR 457 nm for all 16 soilings

| | Sum of ΔR 457 nm for all 16 soilings for simultaneous | | | |
|---|---|---|---|---|
| | and for time-delayed addition of the mixture | | | |
| | of TAED and sodium percarbonate | | | |
| pH | 0 minutes | 15 minutes | 30 minutes | 45 minutes |
| 8.5 | 289 | 311 | 309 | 301 |
| 9.0 | 291 | 296 | 308 | 272 |
| 9.5 | 280 | 299 | 296 | 296 |

The measurement results show that an optimum washing result is achieved if the bleaching agent is metered in within a period of 15 to 30 minutes after the addition of the liquid detergent to the washing liquor.

1. A method for washing and cleaning textiles, which comprises
A) adding a liquid composition comprising one or more surfactants and one or more enzymes but no bleaching agents to the washing liquor comprising water and the textiles to be washed and cleaned and
B) 15 to 30 minutes after adding the liquid composition to the washing liquor, metering one or more bleaching agents into the washing liquor.

2. The method as claimed in claim 1, wherein the liquid composition comprises one or more secondary paraffinsulfonates.

3. The method as claimed in claim 1, wherein the liquid composition comprises one or more anionic surfactants which are selected from the group consisting of the salts of lauric acid, myristic acid, palmitic acid, stearic acid, behenic acid, hydrogenated erucic acid, oleic acid, linoleic acid, linolenic acid and mixtures thereof and the salts of the fatty acids or fatty acid mixtures of natural fats and oils.

4. The method as claimed in claim 1, wherein the liquid composition comprises one or more nonionic surfactants which are selected from condensation products of C₁₀- to C₂₀-alcohols with 2 to 18 mol of ethylene oxide per 1 mol of alcohol.

5. The method as claimed in claim 1, wherein the liquid composition is free from alkanolamines and salts thereof.

6. The method as claimed in claim 1, wherein the liquid composition comprises one or more anionic surfactants and one or more nonionic surfactants.

7. The method as claimed in claim 6, wherein the total concentration of the one or more anionic surfactants and of the one or more nonionic surfactants together in the liquid composition is >10.0% by weight, based on the total weight of the liquid composition.

8. The method as claimed in claim 7, wherein the total concentration of the one or more anionic surfactants and of the one or more nonionic surfactants together in the liquid composition is >50% by weight, based on the total weight of the liquid composition.

9. The method as claimed in claim 6, wherein the one or more anionic surfactants of the liquid composition and the one or more nonionic surfactants of the liquid composition are present in the liquid composition in a weight ratio of anionic surfactant to nonionic surfactant of from 10:1 to 1:10.

10. The method as claimed in claim 1, wherein the liquid composition comprises at least 10% by weight, based on the total weight of the liquid composition, of anionic surfactants.

11. The method as claimed in claim 1, wherein the liquid composition comprises at least 1 to 30% by weight, based on the total weight of the liquid composition, of nonionic surfactants.

12. The method as claimed in claim 1, wherein the liquid composition comprises anionic surfactants and nonionic surfactants, where the content of anionic surfactants is larger than the content of nonionic surfactants, where the content of anionic surfactants is 20 to 40% by weight and the content of nonionic surfactants is 5 to 20% by weight and where the weight data refer to the total weight of the liquid composition.

13. The method as claimed in claim 1, wherein the liquid composition comprises one or more enzymes selected from the group consisting of proteases, amylases, mannases, lipases, endolases, pectinases, cellulases, pullinases, cutinases and peroxidases.

14. The method as claimed in claim 1, wherein the one or more bleaching agents are selected from the group consisting of sodium perborate (monohydrate and tetrahydrate) and sodium percarbonate.

15. The method as claimed in claim 1, wherein the bleaching agent is N,N-phthaloylaminoperoxycaproic acid.

16. The method as claimed in claim 1, wherein the method is carried out in the presence of one or more bleach activators.

17. The method as claimed in claim 16, wherein the one or more bleach activators are present in the liquid composition.

18. The method as claimed in claim 16, wherein the one or more bleach activators are metered into the washing liquor together with the one or more bleaching agents.

19. The method as claimed in claim 16, wherein the one or more bleach activators are selected from the group consisting of tetraacetylethylenediamine, decanoyloxybenzoic acid, n-nonanoyloxybenzenesulfonate and n-lauroyloxybenzenesulfonate.

20. The method as claimed in claim 16, wherein the one or more bleach activators are used in an amount such that the weight ratio of the one or more bleaching agents to the one or more bleach activators is from 25:1 to 1:1.
